(19) United States
(12) Patent Application Publication
(10) Pub. No.: US 2001/0003619 A1
(43) Pub. Date: Jun. 14, 2001

(54) Diluent and desintegrating composition, a process for the preparation thereof and the use thereof

(75) Inventors: Philippe Lefevre, Merville (FR); Patrick Fuertes, Lambersart (FR); Claude Quettier, La Gorgue (FR)

Correspondence Address: HENDERSON & STURM, Suite 1020, 1301 Pennslvania Avenue, N.W., Washington, DC, 20004-1707, US

(73) Assignee: ROQUETTE FRERES

(21) Appl. No.: 09/728,436

(22) Filed: Dec. 1, 2000

(30) Foreign Application Priority Data
Dec. 7, 1999 (FR) 99 15423

(51) Int. Cl. B32B 9/00

(52) U.S. Cl. 428/402.24

(57) ABSTRACT

The invention relates to an diluent and disintegrating composition characterised in that it contains an effective proportion of particles of highly crosslinked starch with limited swelling, enclosed in a matrix of pregelatinised starch.

It also relates to a process for the preparation of this composition and to its use in the production of solid forms.

The invention relates to a diluent and disintegrating composition. It also relates to a process for the preparation of this composition and to the use thereof in industry for the production of solid forms.

The term “solid forms” means any presentation of powder(s) in the form of tablets, pellets, capsules, microspheres or granules. The solid forms consist essentially of inert materials classified under the term excipients, as a complement to one or more pharmaceutical, cosmetic, food, chemical or agrochemical active substances such as flavours, perfumes, detergents, pesticides, antibiotics, enzymes, vitamins. These excipients are generally classified according to their principal function(s). A distinction is thus made between diluents or fillers, binders which ensure the cohesion of the ingredients between one another, disintegrating agents which allow the destruction of the physical integrity of the solid forms when the latter are placed in a suitable fluid. Other excipients may be added in parallel, particularly lubricants in order to improve the flow properties of the powders. A good powder diluent must have the following properties:

chemical compatibility with the active substance,

free flow, to allow regular filling of the dies in modern high-speed moulding machines,

particle size adapted to that of the active substance in order to ensure a constant dosage,

absence of dust to facilitate handling, avoid clogging and to limit the risks of explosion,

high density, to promote flow and limit the size of the final solid form,

cohesion, to ensure the physical stability of the solid forms.

A good disintegrating agent, for its part, must ensure rapid availability of the active substances whilst having satisfactory Theological properties.

The formulator wishes to have a principal excipient having optimum properties which he will complement, according to the properties of the solid form he wishes to develop, with one or more secondary excipients. In fact, there is no universal excipient which has all the properties described above.

Starch and its derivatives are amongst the excipients of choice, offering a wide range of performances for the formulation of solid forms.

In the native state, starch is in the form of granules, the diameter of which ranges from approximately 1 μm to 100 μm.

Its availability and its low cost and its natural origin are the principal factors which favour its use. The majority of commercial starches originate from maize, but wheat and potato are also important sources. Other sources are known, such as rice, manioc and peas.

In the production of solid forms, starch is used as a diluent, binder or disintegating agent.

Native starch, on its own, has a limited number of applications. In fact, when it is used as a diluent in direct compression, its compressibility is insufficient to permit the production of tablets of satisfactory hardness.

Indeed, in the particular case of compression, the particles undergo deformation which may be of different types depending on their nature: elastic or plastic deformation.

In elastic deformation, the deformation disappears when the force ceases to be applied. This deformation is not favourable to the preparation of tablets since the particles revert to their initial state at the end of compression. This is the case in particular with native starches.

In plastic deformation, on the other hand, the deformation persists when the force ceases to be applied, this being entirely favourable to the preparation of tablets.

Moreover, native starch has poor flow properties, with the result that it is not recommended in formulations for direct compression. This is due to the small size of its particles, and to its low density. However, the fluidity of the formulations is an essential criterion which determines the uniformity of weight of the finished tablets. On the other hand, native starch has good disintegrating properties. In fact, starch granules swell in the presence of water which causes bursting of the structure in which they are contained, and hence the disintegration thereof.

Native starch may be modified in a simple and inexpensive manner by a heat treatment causing the granules to burst and partial hydrolysis of the polymer chains. A pregelatinised starch is thus obtained which, in the form of a powder and for a selected particle size, is a product having good flow and compression properties but practically zero disintegrating capacity. It is used preferably as a binder for powders.

Chemical modifications such as crosslinking as described in patent U.S. Pat. No. 4,369,308 may be made to pregelatinised starch, but these lead to a poor quality disintegrating agent.

In view of the fact that the properties of pregelatinised starch and of native starch are diametrically opposed but nevertheless both required at the same time in numerous solid forms, a simple mixture of the two powders might have been envisaged. However, these two starches have very divergent particle sizes, which leads to rapid “demixing” of the powders at the slightest handling, and a very fluctuating homogeneity of the final solid form, which is industrially unacceptable.

The patent FR 1 583 232 proposed, therefore, a compacting process which leads to a partially pregelatinised starch. The product obtained according to this process and sold under the name of STARCH 1500® has good binder and diluent properties but its disintegrating capacity remains limited and its flow properties are mediocre, necessitating the use by the formulators of additional excipients (VISAVARUNGROJ N, RENON J. P., (1992) Pharm. Tech. Int. JAN/FEV p26-32).

Moreover, the use of this process, which is complex and expensive, does not allow good control of the particle size, which leads to a great variation in the properties offered by this product.

More recently, another process for the preparation of directly compressible pregelatinised starch has been proposed in the patent EP 402 186. The product obtained, sold under the name of SEPISTAB® ST 200, is the result of wet granulation of native starch by a solution of starch paste. This process, which requires a large proportion of native starch, leads to a powder whose granules are friable and fragile, which militates against the use of this powder on high-speed industrial machines which generate considerable physical stress.

Finally, the patent application EP 933 079 describes a starch partially cooked at low temperature then atomised. The product thus obtained has a low density, and atomisation is an expensive process and not without risks if viscous products such as starch pastes are used.

Consequently, none of the processes of the prior art allow the preparation, in an economically acceptable manner, of starch compositions simultaneously having good diluent and disintegrating properties.

The object of the invention is, therefore, to overcome the disadvantages of the prior art and to supply an diluent and disintegrating starch composition which meets the various practical requirements more satisfactorily than those which already exist.

The Applicant company has, to its merit, found that this aim was achieved by the use of a pregelatinised starch containing a not inconsiderable quantity of highly crosslinked starch granules with limited swelling.

More specifically, the diluent and disintegrating composition according to the invention is characterised in that it contains an effective proportion of highly crosslinked starch particles, with limited swelling, enclosed in a matrix of pregelatinised starch.

The invention also relates to a process for the preparation of a diluent and disintegrating composition having the characteristics set out above.

The term effective proportion means that which is necessary and sufficient to obtain the desired effect, that is, good diluent and disintegrating properties.

The term “pregelatinised starch” means any starch that has undergone a heat treatment in the presence of water, with the result that it loses its granular structure completely, it no longer exhibits any birefringent or non birefringent granules under an optical microscope, and it becomes more or less soluble in cold water. The term “starch” means starches of any origin, natural or hybrid, modified or unmodified, and any mixtures thereof.

The term “crosslinked starch” means any starch which has undergone the action of one or more crosslinking agents, having retained its granular structure but having a limited capacity to swell in water.

The diluent and disintegrating composition according to the invention is composed of highly crosslinked starch granules with limited swelling, that is, which have not burst, which are coated partly or wholly with pregelatinised starch, the latter having lost its granular structure. The particular nature of this composition gives it, by itself, all the properties required in the formulation of solid forms, properties which had never been combined hitherto in a single product of the prior art. This makes it possible to consider numerous applications of the composition according to the invention in a new light, particularly in the production of tablets, capsules, granules or any other solid form likely to require an excipient having said properties. Moreover, crosslinked starch has greater heat resistance and mechanical strength than standard starches, which allows envisaging sterilisation and granulation-drying treatments or any other treatment carried out on the solid form which may represent a physical stress.

In accordance with a preferred characteristic of the invention, the diluent and desintegrating composition contains a proportion of highly crosslinked starch in the range 20% to 90%, this percentage being calculated by weight with respect to the total weight of crosslinked starch and of pregelatinised starch contained in said composition. Preferably, this proportion is in the range 30% to 80%, and even more preferably 40% to 60%.

The Applicant has, in fact, shown, after lengthy research, that this second feature made it possible to obtain, advantageously, good diluent and disintegrating properties simultaneously.

Thus, with proportions exceeding 90% of highly crosslinked starch in the composition, it generally becomes impossible to form a matrix of pregelatinised starch enclosing granules of intact starch and, by the same token, to obtain all the properties characterising the composition according to the invention. Moreover, with proportions below 20% of highly crosslinked starch, the disintegrating properties are not generally satisfactory.

With regard to the apparent density of the composition according to the invention, which represents a criterion of interest for the formulator, this is advantageously greater than 0.5 g/ml.

The apparent density or apparent density before packing was measured according to analytical method 2.9.15 of the European Pharmacopoeia, 3rd edition.

The principle of this measurement is based on the determination of the volumes before and after packing of the powders and employs an apparatus comprising a tapping device provided with a graduated cylinder, said device giving rise to successive falls of the measuring cylinder containing the powder to be tested.

The Applicant has thus shown that an apparent density at least equal to 0.5 g/ml made it possible to obtain a particularly satisfactory flow of the composition according to the invention and that, for its use particularly in the filling of capsules, a high density made it possible to reduce the size of the capsule, which is entirely appropriate for facilitating its ingestion by the patient in the case of pharmaceutical capsules. A diluent and disintegrating composition containing at least 10 wt. % of completely pregelatinised starch, this percentage being expressed with respect to the total weight of starch contained in said composition, and having an apparent density greater than 0.5 g/ml, constitutes a particularly suitable product for the preparation of solid forms, which differs all the more from the pregelatinised starches of the prior art in that the particle size associated with this density is large.

The Applicant has also shown that the particle size of the composition according to the invention could lie within a very wide range without the diluent and disintegrating properties being adversely affected. This property was calculated from the oversize obtained by sieving on successive sieves with decreasing apertures. The average particle size of the composition according to the invention may be, in particular, in the range 50 μm to 1000 μm.

This makes it possible, advantageously, to adapt at will the particle size of the composition according to the invention to that of the active substance whilst retaining all the properties mentioned above.

The diluent and disintegrating compositions according to the invention may be obtained according to a multitude of variants but more particularly according to a process comprising the following steps:

preparation of a milk of starch and of a highly crosslinked starch,

cooking this milk at a temperature below 130° C., and preferably below 110° C., in order to obtain a paste,

drying this paste,

grinding the dried paste,

recovering the diluent and disintegrating starch composition thus obtained.

The properties may be adjusted by modifying the crosslinked starch proportion of the starting milk.

The preparation of the highly crosslinked starch consists in bringing the starch into contact with a crosslinking agent capable of forming bonds between the starch molecules. The crosslinking agents used are those which are highly suitable for pharmaceutical or food uses, such as phosphorus oxychloride, soluble metaphosphates, epichlorohydrin, carboxylic acid anhydrides, adipic-acetic anhydride, and acrolein. It is also possible, however, to use other known crosslinking agents such as formaldehyde, diisocyanates, if the final product is not intended to be ingested.

Preferably, sodium trimetaphosphate or phosphorus oxychloride are used.

The crosslinking itself may be carried out according to any method known to the skilled person for preparing crosslinked starches in the liquid or dry phase. The operating conditions must, however, be sufficient to bring about a high degree of crosslinking. This degree of crosslinking, which cannot be measured directly, is evaluated by means of the sedimentation test of the United States Pharmacopeia (USP 23, p 563). A sample of 10 grammes of starch to be tested, weighed out exactly, is introduced into a 250 ml beaker. 90 ml of distilled water measured by means of a measuring cylinder, are added and the mixture homogenised. The mixture is then boiled gently over a Bunsen burner and boiling is continued for 20 minutes. The contents are stirred for the first five minutes using a glass rod. Stirring is carried out intermittently over the next fifteen minutes. The contents are cooled to ambient temperature and transferred to the measuring cylinder. The contents are made up to 100 ml with distilled water, homogenised rapidly and left to stand for 24 hours. The volume decanted, which is expressed in milliliters, is finally read off. The degree of sedimentation is expressed in milliliters decanted per 100 ml used. The greater the degree of crosslinking, the lower the degree of sedimentation. Thus, a standard unmodified starch will have a degree of sedimentation of about 100%. The term highly crosslinked starch means, within the meaning of the invention, a starch with a degree of crosslinking which makes it possible to obtain a degree of sedimentation of less than 65%. A composition according to the invention prepared with a crosslinked starch having a degree of sedimentation of more than 65% no longer fulfils the required disintegrating functions. Preferably, the degree of sedimentation of the highly crosslinked starch is less than 60%.

As regards the preparation of the milk of standard starch and highly crosslinked starch, it is preferable if the latter has a dry substance content of at least 30%.

The steps of cooking and drying may be carried out by any method known to the skilled person.

The cooking temperature of the milk is preferably around 100° C.

Similarly, grinding is carried out according to any type of known method which makes it possible to obtain a powder having the desired granulometric properties.

According to an advantageous embodiment of the process according to the invention, a milk is prepared containing in the range 20% to 90%, preferably 30% to 80% and even more preferably 40% to 60% of highly crosslinked starch, this percentage being expressed by weight of crosslinked starch with respect to the total weight of starches contained in the milk.

According to a preferred variant of the above-mentioned process, the cooking temperature of the starch milk is in the range 80° C. to 105° C.

The Applicant company has shown that it was possible, advantageously, to produce the composition according to the invention using a drum drier. Such a piece of equipment makes it possible to reproduce, using a single device, the cooking and drying steps of the process according to the invention.

This well known equipment, by making use of the heat transferred from the surface of the steam-heated drums to the starch milk, makes it possible in fact to gelatinise this milk which is spread uniformly in a thin film over the hot surface of the drum by applicator components.

The film thus formed is then scraped by means of a scraper knife so as to remove a sheet which is then ground in order to obtain a composition according to the invention.

An important advantage of the process according to the invention lies in the fact that its use applied to the starch milk according to the invention is simple and inexpensive. It also makes it possible to obtain a homogeneous composition comprising particles of crosslinked starch with limited swelling enclosed in a matrix of pregelatinised starch, which is not likely to give rise to segregation when it is used to produce solid forms. Moreover, the process makes it possible to obtain a wide range of disintegrating compositions according to the invention by adjusting the proportions within the mixture of starch and highly crosslinked starch without this being detrimental to the diluent properties of said compositions, and by making various combinations of different sources of starch. Moreover, it is possible at any moment of this process, therefore before, during and/or after the grinding step described above, to bring the starch composition into contact with one or more non-starch constituents such as, for example, active substances, preservatives, excipients, with or without diluent or disintegrating properties, provided that such constituents do not have an adverse effect on the desired properties of the final mixture.

Whatever the case, the compositions according to the invention have diluent and disintegrating properties which are superior to those of the starch products of the prior art.

A possible explanation for these remarkable properties is that the cooking-drying treatment applied to the starch milk gives rise to an unexpected densification of the mixture whilst keeping granules of crosslinked starch with limited swelling in an effective proportion which, for their part, ensure the desired disintegrating capacity, and increased physical strength.

The composition according to the invention may thus be used advantageously in the production of solid forms as a diluent and disintegrating agnet, whether in the food, pharmaceutical, cosmetic, chemical or agrochemical sectors.

The advantages of the present invention will be understood more readily on reading the examples below.

### EXAMPLE 1

### Preparation of a composition according to the invention and comparison with compositions of the prior art

A highly crosslinked starch is prepared under the following conditions:

A maize starch milk with a 40% dry substance content is prepared. The temperature is adjusted to 40° C. and the pH is adjusted to 11.5 by means of a 35 g/l sodium hydroxide solution.

4% of sodium trimetaphosphate based on dry substance is added to this starch milk.

After a reaction time of 8 hours, the milk is neutralised to a pH of about 5 using hydrochloric acid. The starch milk is then washed to obtain a conductivity of around 200 μS.

The degree of sedimentation of this starch, measured by the USP method, is 55%.

A composition containing 50% of standard starch and 50% of highly crosslinked starch prepared beforehand is then prepared.

The milk thus prepared is cooked over a single-cylinder drum drier at a temperature of 100° C.

The main physical characteristics of the composition obtained are given in the table below, in comparison with a standard maize starch and a pregelatinised maize starch sold by the Applicant under the brand name LYCATAB® PGS.

| | Composition acc. | | |
|---|---|---|---|
| | to invention | Maize starch | LYCATAB ® PGS |
| Mean | 81 | 13.8-14.5 | 90 |
| diameter (1) | | | |
| (microns) | | | |
| Apparent | 0.63 | 0.43 | 0.45 |
| Volumic mass | | | |
| before | | | |
| packing (2) | | | |
| (g/ml) | | | |
| Apparent | 0.85 | 0.74 | 0.59 |
| Volumic mass | | | |
| after | | | |
| packing (2) | | | |
| (g/ml) | | | |
| Flowability | 4.3 | infinite | 9 |
| (3) | | | |
| (seconds) | | | |
| Packing | 26 | 54 | 31 |
| behaviour (4) | | | |
| (ml) | | | |

The mean diameter is calculated from the particle size measured by sieving over successive sieves of 200, 100, 80, 63 and 40 microns, except in the case of maize starch, of which the value used is that cited in WHISTLER R. L., BEMILLER J. N., PASCHALL E. F., (1984), Starch Chem. and Techn., 2nd ed.

The apparent volumic mass is measured according to pharmacotechnical method 2.9.15 of the European Pharmacopoeia, 3rd edition.

The flowability is measured according to pharmacotechnical method 2.9.16 of the European Pharmacopoeia, 3rd edition.

The packing behaviour is measured according to pharmacotechnical method 2.9.15 of the European Pharmacopoeia, 3rd edition.

It is concluded from these results that the compositions according to the invention have an apparent density which is greater than that of the products of the prior art, and has better flowability.

### EXAMPLE 2

### Evaluation of the disintegrating capacity of the composition prepared according to example 1, comparison with the products of the prior art

The disintegrating properties are evaluated according to the following test:

Flat tablets 13 mm in diameter, 5 mm thick weighing 1 g and having a density of 1.465 are prepared on a reciprocating press of the FROGEPAIS AM type and have the following composition:

composition according to example 1: 49.5%

dicalcium phosphate dihydrate for direct compression (ENCOMPRESS®) : 50%

magnesium stearate : 0,5%

(ENCOMPRESS® is sold by MENDELL)

The disintegration times of these tablets are measured according to pharmacotechnical method 2.9.1 of the European Pharmacopoeia, 3rd edition.

The disintegration times indicated below are the times required for the complete disintegration of the tablet.

| | Composition acc. | Pregelatinised | |
|---|---|---|---|
| | example 1 | starch | STARCH ® 1500 |
| Average | 2 mn 24s | >15 mn | 2 mn 45s |
| disinteg- | | | |
| ration time | | | |

It is concluded from these results that the composition according to the invention has a clear disintegrating function which is greater than that of the compositions of the prior art.

The granules of highly crosslinked starch enclosed in the matrix of pregelatinised starch therefore have a sufficient disintegrating function to oppose the binding action of the pregelatinised starch.

The compositions according to the invention therefore combine, advantageously, properties which had never hitherto been found simultaneously within the same starch composition. In fact, they possess diluent and disintegrating properties at the same time, in other words, a high density, good flow properties, a suitable particle size and rapid disintegration.

### EXAMPLE 3

Two compositions according to the invention containing potato starch crosslinked to two different levels, and standard wheat starch were prepared in proportions of 50/50.

Composition A contains 50% of crosslinked potato starch of which the degree of sedimentation is 77%.

Composition B contains 50% of crosslinked potato starch of which the degree of sedimentation is 65%.

Compositions A and B are then cooked over a drum drier under the conditions of example 1.

Tablets are then prepared with these two compositions under the conditions of example 2.

The characteristics of these tablets are set out in the table below:

| | Composition A | Composition B | Composition of |
|---|---|---|---|
| | (potato and | (potato and | example 1 |
| | wheat starch) | wheat starch) | (maize starch) |
| Degree of | 77% | 65% | 55% |
| sedimentation | | | |
| of the | | | |
| crosslinked | | | |
| fraction | | | |
| Average weight | 993 | 1006 | 995 |
| of the tablets | | | |
| (mg) | | | |
| Average | 5.01 | 5.04 | 4.93 |
| thickness of | | | |
| the tablets | | | |
| (mm) | | | |
| Density of the | 1.49 | 1.505 | 1.520 |
| tablets | | | |
| Average | 20 min 23s | 6 min 31s | 2 min 24s |
| disintegration | | | |
| time (min) | | | |

These results show that the degree of sedimentation of the crosslinked fraction is advantageously less than or equal to 65% since, at values above this, the disintegration time is not satisfactory.

1. An diluent and disintegrating composition, comprising an effective proportion of highly crosslinked starch particles with limited swelling, enclosed in a matrix of pregelatinised starch.

2. A composition according to claim 1, comprising in the range 20 wt. % to 90 wt. % of highly crosslinked starch, these percentages being expressed with respect to the total weight of starch contained in said composition.

3. A composition according to claim 2, comprising in the range 30 wt. % to 80 wt. % of highly crosslinked starch, these percentages being expressed with respect to the total weight of starch contained in said composition.

4. A composition according to claim 3, comprising in the range 40 wt. % to 60 wt. % of highly crosslinked starch, these percentages being expressed with respect to the total weight of starch contained in said composition.

5. A composition according to claim 1, having an apparent density greater than 0.5 g/ml, and/or an average particle size in the range 50 μm to 1000 μm.

6. A diluent and disintegrating composition according to claim 1, wherein the highly crosslinked starch has a degree of sedimentation less than or equal to 65%.

7. A diluent and disintegrating composition according to claim 6, wherein the highly crosslinked starch has a degree of sedimentation less than or equal to 55%.

8. A process for the preparation of a diluent and disintegrating composition according to claim 1, comprising the steps consisting of:
preparing a milk of starch and of highly crosslinked starch,
cooking the milk thus obtained at a temperature below 130° C. in order to obtain a paste,
drying said paste,
grinding the dried paste,
collecting the diluent and disintegrating composition thus obtained.

9. A process according to claim 8 where the milk is cooked at the temparature below 110° C.

10. A process according to claim 8, wherein the starch milk contains in the range 20 wt. % to 90 wt. % of highly crosslinked starch, these percentages being expressed with respect to the total weight of starch and of highly crosslinked starch contained in the milk.

11. A process according to claim 10, wherein the starch milk contains in the range 30 wt. % to 80 wt. % of highly crosslinked starch, these percentages being expressed with respect to the total weight of starch and of highly crosslinked starch contained in the milk.

12. A process according to claim 11, wherein the starch milk contains in the range 40 wt. % to 60 wt. % of highly crosslinked starch, these percentages being expressed with respect to the total weight of starch and of highly crosslinked starch contained in the milk.

13. A process according to claim 8, wherein the cooking temperature of the milk is in the range 80° C. to 105° C.

14. A process according to claim 8, wherein the dried paste is ground in order to obtain a particle size in the range 50 μm to 1000 μm.

15. A process according to claim 8, wherein the cooking and drying of the starch milk are carried out over a drum drier.

16. A solid form comprising a composition according to claim 1, or obtained by using a process according to claim 8.
